(19) United States
(12) Patent Application Publication
(10) Pub. No.: US 2026/0004161 A1
(43) Pub. Date: Jan. 1, 2026

(54) GENERATIVE AI-BASED SYSTEM WITH LEARNING AND IMAGINATION CAPABILITIES FOR DOMAIN EXPERT APPLICATIONS

(71) Applicant: GOWell International, LLC, Houston, TX (US)

(72) Inventors: Ayman El Aassal, Houston, TX (US); Gavin R. Johnson, Houston, TX (US)

(21) Appl. No.: 19/193,858

(22) Filed: Apr. 29, 2025

Related U.S. Application Data
(60) Provisional application No. 63/665,645, filed on Jun. 28, 2024.

(51) Int. Cl. G06N 5/022

(52) U.S. Cl. CPC G06N 5/022

(57) ABSTRACT

A system capable of reasoning, learning, and imagination. The system includes an input/output module, a reasoning and decision agent, and a knowledge management module including a deliberation agent and a semantic knowledge space. This system uses prior knowledge stored in memory for reasoning and decision-making. It learns new domain knowledge and user behavior throughout operation, making it an evolving system that adapts to the user's needs. The system reinforces knowledge stored in its semantic memory without user intervention and imagines new relationships between existing concepts to search for novel ideas until it reaches an epiphany. Several embodiments of the disclosed system can interact in a collaborative environment for cross-domain reasoning and brainstorming new ideas.

### CROSS-REFERENCE TO RELATED APPLICATIONS

This application claims priority from a U.S. Provisional Patent Application No. 63/665,645, filed on Jun. 28, 2024, which is incorporated herein by reference in its entirety.

### FIELD OF INVENTION

The present invention relates to artificial intelligence and expert systems, and more particularly, the present invention relates to an evolving AI-based expert system capable of cognitive function, including learning new domain knowledge and forgetting old knowledge, reasoning and attention, imagination, and brainstorming to get epiphanies about novel ideas.

### BACKGROUND

An expert system is software that uses artificial intelligence (AI) to solve problems, make decisions, and provide recommendations within a specific domain. The AI-based expert system is designed to solve complex problems through reasoning similar to human experts. Originally, expert systems were introduced in the 1960s to solve complex decision problems. Now, expert systems have become an important application of artificial intelligence.

Many fields in artificial intelligence have significantly evolved in the last decade, however, the expert systems remain limited in their ability to evolve and adapt to a dynamic environment. Their logic is limited by the predefined tasks they were designed for, which impair their reasoning abilities when dealing with new or unexpected events. Additionally, the performance of an expert system depends heavily on the accuracy and completeness of its knowledge base, which is costly and time-consuming to periodically update and maintain.

The above-described limitations showcase the need for an AI-based expert system that, like a human expert, applies reasoning and prior experience to solve novel tasks, learn new knowledge, and use imagination and cross-domain knowledge to discover new ideas and insights.

### SUMMARY OF THE INVENTION

The following presents a simplified summary of one or more embodiments of the present invention to provide a basic understanding of such embodiments. This summary is not an extensive overview of all contemplated embodiments and is intended to either identify key or critical elements of all embodiments nor delineate the scope of any or all embodiments. Its sole purpose is to present some concepts of one or more embodiments in a simplified form as a prelude to the more detailed description that is presented later.

The principal object of this disclosure is therefore directed to an evolving AI-based expert system that learns new domain knowledge, applies reasoning and attention, and uses imagination and brainstorming to get epiphanies about novel ideas.

An object of this embodiment is that the AI-based expert system applies reasoning based on prior knowledge and information perceived from its environment to make decisions and execute tasks.

Yet another object of this embodiment is that the expert system interacts with an operator using natural human language (NHL), such as English, and learns new knowledge provided by the operator in the form of documents or NHL through its input/output interface.

Still, another object of this embodiment is that the AI-based expert system, without the intervention of an operator, reinforces its knowledge about relevant topics in its domain of expertise and forgets outdated and irrelevant knowledge.

Another object of this embodiment is that the AI-based expert system uses abstract reasoning and imagination to find new ideas and get epiphanies.

A further object of this embodiment is that different AI-based expert systems are put in a collaborative environment to brainstorm new ideas through cross-domain reasoning.

In one aspect, disclosed is an AI-based expert system that includes an input/output module, a reasoning and decision agent, and a communication module. The reasoning and decision agent includes a large language model (LLM) for reasoning, planning, and decision-making. The input/output module includes an interface to perceive information from its environment. The communication agent includes an LLM to support interactions with an operator in NHL. The AI-based expert system also includes a deliberation agent, which includes an LLM to organize and reinforce knowledge, and a semantic domain knowledge space.

In one aspect, disclosed is an AI-based expert system and a method for applying reasoning and prior experience to solve novel tasks, learn new knowledge, and use imagination and cross-domain knowledge to discover new ideas and insights.

In one aspect, disclosed is an AI-based expert system capable of reasoning, learning, and imagination. The AI-based expert system comprises a processor and a memory. The AI-based expert system is configured to implement a method comprising: receive, via a communication agent, a request in natural language from an operator device through a user interface, wherein the communication agent utilizes a large language model to facilitate natural language interaction; identify, by a Reasoning and Decision Agent, key phrases from the request; determine, by the Reasoning and Decision Agent, a current task based on the key phrases; retrieving, by the Reasoning and Decision Agent, prior knowledge relevant to the current task from a Semantic Domain Knowledge Space comprising an episodic knowledge space and a semantic knowledge space, wherein the semantic knowledge space comprises a knowledge graph, the knowledge graph comprises vertices and edges; processing, by the Reasoning and Decision Agent, the prior knowledge based on the request to generate a list of tasks; transmit, by the Reasoning and Decision Agent, the list of tasks as commands to a functional actuator; and execute, by the functional actuator, one or more actions based on the transmitted commands.

In one aspect, the Reasoning and Decision Agent is further configured to retrieve relevant information for the current task, from real-world domain events, through sensors or data feed, wherein the Reasoning and Decision Agent processes the relevant information and the prior knowledge to generate the list of tasks.

In one aspect, the Semantic Domain Knowledge Space is configured to encapsulate knowledge as vertices and edges in the knowledge graph, wherein the vertices represent keywords and concepts from a domain of expertise, and edges denote semantic relationships of the keywords and concepts and frequency with which the keywords and concepts co-occur.

In one aspect, the method further comprises: storing, by a Deliberation Agent, a consolidated history of the request, the current task, and the corresponding list of actions as the prior knowledge in the Semantic Domain Knowledge Space.

In one aspect, the method further comprises: receive, by the communication agent, new knowledge; parse, by the communication agent, the new knowledge into a structured format; extract Keywords, concepts, and their relationships from the structured new knowledge, by the Reasoning and Decision Agent; initialize a knowledge acquisition process by a Deliberation Agent, wherein the knowledge acquisition process comprises recalling existing information in the Semantic Domain Knowledge Space for context to better understand the keywords and concepts in the new knowledge; and consolidate, by the Deliberation Agent, the new knowledge, including important concepts, their contextual meaning, and their relationships in the Semantic Domain Knowledge Space.

In one aspect, the episodic knowledge space is a digital storage module configured to store episodes in a sequence they appear in a perceived electronic document, wherein an episode is a segment of text referenced by the vertices in the knowledge graph, with each vertex corresponding to a term present within that segment of text.

In one aspect, the semantic knowledge space comprises high levels of abstraction and low levels of abstraction, wherein the vertices represent concepts and keywords, and the edges represent relationships between concepts and keywords, wherein each vertex is linked to the episodes containing the corresponding concepts and keywords.

In one aspect, the method further comprises: reinforce recalled knowledge about concepts and their relationships through potentiation and forgetfulness; and renew the reinforced knowledge into the semantic knowledge space, wherein the potentiation is increasing the weight of existing vertices and edges, and adding vertices and edges corresponding to the recalled concepts and relationships, wherein the forgetfulness is reducing the weight of vertices and edges, and deleting vertices and edges corresponding to the recalled concepts and relationships.

In one aspect, wherein the method further comprises: combine, by the deliberation agent, recalled episodes within the episodic knowledge space into one episode when there is a predetermined number of common vertices referring to these episodes in the semantic knowledge space.

In one aspect, the method further comprises: initiate imagination by exploring and creating new connections between concepts within the semantic knowledge space; and generate new insights and stories based on the new connections.

In one aspect, disclosed is a method for reasoning, learning, and imagination, the method implemented within an AI-based expert system comprises a processor and a memory, the method comprising: receiving, by a communication agent, a request in natural language from an operator device through a user interface, wherein the communication agent utilizes a large language model to facilitate natural language interaction; identifying, by a Reasoning and Decision Agent, key phrases in the request; determining, by the Reasoning and Decision Agent, a current task based on the key phrases; retrieving, by the Reasoning and Decision Agent, prior knowledge relevant to the current task from a Semantic Domain Knowledge Space comprising episodic knowledge space and semantic knowledge space, wherein the semantic knowledge space comprises a knowledge graph, the knowledge graph comprises vertices and edges; processing, by the Reasoning and Decision Agent, the prior knowledge based on the request to determine a list of tasks; receiving, by a functional actuator, the list of tasks as commands from the Reasoning and Decision Agent; and executing one or more actions, by the functional actuators, based on the commands.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the AI-based expert system, according to an exemplary embodiment of the present invention.

FIG. 2 is a block diagram showing the architecture of the system, according to an exemplary embodiment of the present invention.

FIG. 3 shows an overview of the disclosed AI-based expert system, according to an exemplary embodiment of the present invention.

FIG. 4 illustrates a step of performing a task of the disclosed process requested by an operator, according to an exemplary embodiment of the present invention.

FIG. 5 illustrates the components of the disclosed AI-based expert system involved in learning new knowledge, according to an exemplary embodiment of the present invention.

FIG. 6 illustrates the sequential steps involved in learning new knowledge by the disclosed AI-based expert system, according to an exemplary embodiment of the present invention.

FIG. 7 illustrates the sequential steps taken by the reasoning and decision agent to answer a request, according to an exemplary embodiment of the present invention.

FIG. 8 illustrates the design and components of the semantic domain knowledge space, according to an exemplary embodiment of the present invention.

FIG. 9 illustrates the knowledge reinforcement process initiated by a deliberation agent, which involves recalling and renewing knowledge from the semantic domain knowledge space, according to an exemplary embodiment of the present invention.

FIG. 10 illustrates the knowledge reinforcement process initiated by the deliberation agent, which involves recalling and merging episodes from the semantic domain knowledge space, according to an exemplary embodiment of the present invention.

FIG. 11 shows the main steps of knowledge consolidation performed by the deliberation agent, according to an exemplary embodiment of the present invention.

FIG. 12 is a flowchart illustrating the method to reach epiphanies through learning, reinforcing knowledge, and imagination, according to an exemplary embodiment of the present invention.

FIG. 13 illustrates an operational mode where AI-based expert systems engage in AI brainstorming in a collaborative environment, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention, since the scope of the invention will be best defined by the allowed claims of any resulting patent.

The terminology used herein is to describe particular embodiments only and is not intended to be limiting to embodiments of the invention. As used herein, the singular forms “a”, “an”, and “the” are intended to include the plural forms as well, unless the context clearly indicates otherwise. It will be further understood that the terms “comprise”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

### Definitions:

Real-world domain events: Events or signals perceived by the system that occur in the environment of the invention. These signals can be physical and can be perceived through sensors or electronic, such as receiving data from another computer in the network.

Operator: A domain expert that uses their knowledge and expertise to operate, monitor, and interact with the invention. A user of the invention in general terms.

Request: Questions or commands from the operator to the system.

Actions: The operations executed by the system, including answering questions, modifying data, controlling hardware, or interacting with other software components.

Interaction: The process through which the system communicates or exchanges information with users, other systems, or its environment. This can involve natural language conversations, API calls, sensor data processing, or control signals to hardware.

Actuator: A functional component (software function, API, or hardware controller) that enables the system to execute actions by interfacing with external systems, controlling devices, or accessing databases. These actuators could be a motor that moves a robotic arm, a mechanism that controls valves in industrial equipment, or software functions that control digital or electronic devices.

Task: Specific objectives or operations that the AI agent is responsible for performing, either autonomously or in response to a request. Tasks can include data processing, planning and decision making, automation, or executing operations within the domain of expertise.

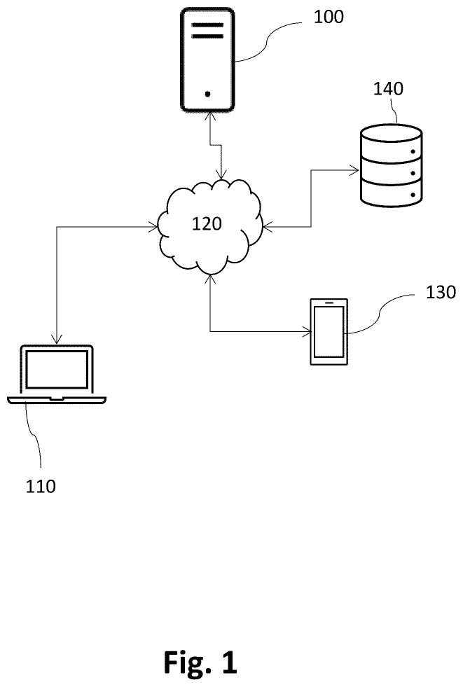

The invention described pertains to a generative AI-based system with learning and imagination capabilities for domain expert applications. Referring to FIG. 1, a block diagram showing the environment of the disclosed system 100. The system 100 can connect to the operator device 110 and another user device 130 through a network 120. The operator is a domain expert who uses their knowledge and expertise to operate, monitor, and interact with the invention, such as doctors, lawyers, and engineers. The operator and the other users are also referred to herein as users. The term “user” as used herein and throughout this disclosure refers to an individual engaging a user device to interact with the system. Similarly, the term user device encompasses operator devices and other user devices. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include network circuitry for connecting to the network 120. Examples of the user device include a smartphone, a desktop computer, a laptop, a workstation, and the like.

The system may also communicate with external devices 140 for uploading and/or downloading data through the network 120. Examples of external devices include IoT devices, actuators, CRM systems, Database servers, Edge Computing devices, cloud services, and HMI devices.

The network can be a communication network known in the art, which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for the purpose of illustration herein, FIG. 1 shows a single network connecting multiple user devices, it should be obvious to those reading this disclosure that different user devices can connect with the system through various networks, and the same user device can connect with the system through more than two networks. For example, a user device can connect to the system through a LAN and the Internet.

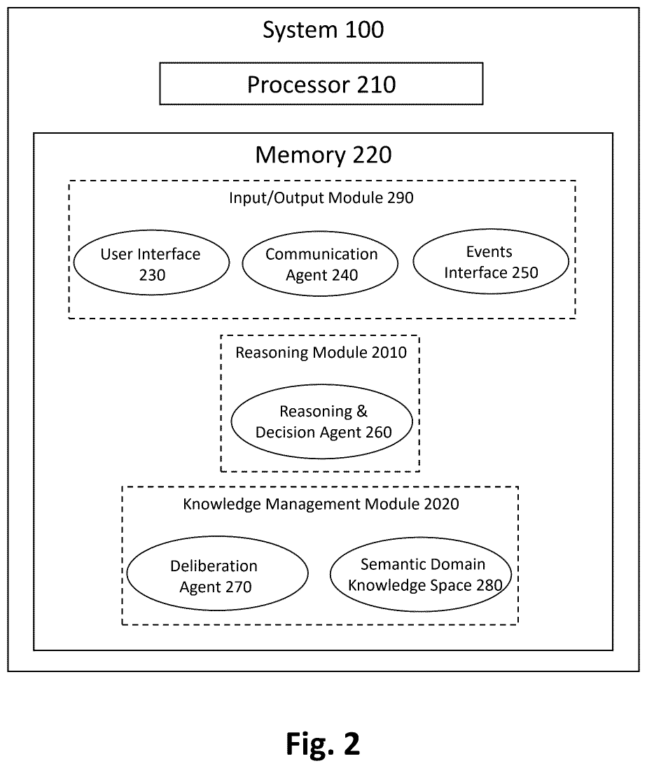

Referring to FIG. 2, which shows the architecture of the system 100. System 100 includes a processor 210 and a memory 220 operably coupled to the processor. The processor can be any logic circuitry that responds to and processes instructions fetched from memory. The memory may include one or more memory chips capable of storing data and allowing any storage location to be directly accessed by the processor. The memory can include modules and agents according to the present invention for execution by the processor to perform one or more steps of the disclosed methodology.

The memory may include an Input/Output module 290, which contains a User Interface 230, a Communication Agent (CA) 240, and an Events Interface 250. The memory also includes a Reasoning Module 2010 that contains a Reasoning and Decision Agent (RDA) 260. The memory further includes a Knowledge Management Module 2020, which includes a Deliberation Agent (DA) 270 and Semantic Domain Knowledge Space (SDKS) 280.

An agent is a software component that leverages one or multiple large language models to execute tasks autonomously using a functional actuator. These functional actuators are computer functions that enable the agent to interact with other software components, control hardware, or access external databases. The tasks that an agent can execute include logging and monitoring system activities, processing real-time sensor data, controlling robotic arms, managing IoT devices, summarizing data, and generating reports etc.

The term module, as used herein and throughout this disclosure, refers to software, a program code, a set of rules or instructions, and the like in one or more computer-readable languages, including graphics, which, upon execution by the processor, performs one or more steps of the disclosed methodology. Also, operations may be described as a sequential process; some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

The User Interface 230 included in the Input/Output module 290 allows a user to interact with the disclosed system through a user device. The interface may include a series of screens that, in continuation, can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™, operated and developed by Google, and the App Store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100, and information can be received by system 100 from the user.

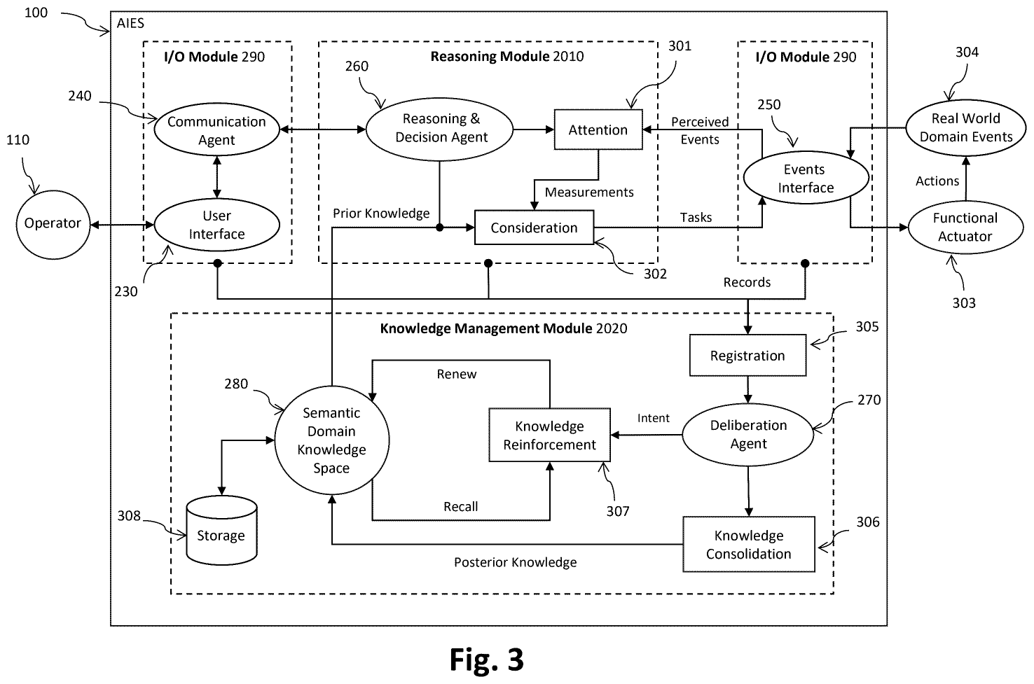

Now, referring to FIG. 3, which illustrates an overview of the disclosed AI-based Expert System 100. The disclosed system includes various modules and/or agents that, upon execution by the processor, perform one or more steps of the disclosed methodology. The disclosed system includes various modules containing agents, which, upon commands by the processor, perform one or more steps of the disclosed methodology. Communication Agent 240 uses a Large Language Model (LLM) to enable and facilitate natural language communication with operator 110.

Operator 110 can use the User Interface 230 to input information into the system 100, which is then forwarded to and processed by the Communication Agent 240. The input information can be in various formats, including text, audio, or video. For example, plain text, prompts, PDF documents, Word files, meeting notes, scanned documents, audio recordings, real-time speech, seminar videos, and other similar formats are commonly used for sharing and storing data digitally.

Communication Agent 240 can extract requests and actionable items from interactions with the operator device. These interactions refer to the exchanges of information or communications between the operator device and the Communication Agent. They involve the previously mentioned forms of input, such as spoken commands, recorded audio, scanned documents, or other data transmissions.

The Reasoning and Decision Agent 260 uses a Large Language Model (LLM) that can use prior knowledge, including domain-specific expertise and historical feedback, to fulfill the requests received from the operator device 110. A request is a command, query, or instruction that prompts the Reasoning and Decision Agent 260 to perform a specific action, retrieve information, or process data. The Deliberation Agent 270 uses a Large Language Model (LLM), and upon execution by the processor, can consolidate the history of interactions with the operator device and store it in a Semantic Domain Knowledge Space 280. The history of interactions includes requests, feedback, and other forms of documentation received from the operator device. Semantic Domain Knowledge Space (SDKS) 280 acts as a semantic memory and contains a knowledge graph 801.

The Events Interface 250 is a software component or code that supports real-time communication and data exchange methods and protocols between the system 100 and external software, devices, sensors, or embedded systems. These protocols include HTTP/HTTPS, Message Queuing Telemetry Transport (MQTT), Bluetooth®, WebSockets, and the like.

Functional actuators 303 is a computer function, program, or embedded system, that can receive commands or instructions from the Reasoning and Decision Agent 260 to perform actions in the digital or physical world. These actions can involve interacting with software components, controlling hardware, modifying data, or triggering processes to fulfill the agent's objective.

Again, referring to FIG. 3, the disclosed system 100 can interact with an operator device 110 through the User Interface 230. It can also send orders or commands to a functional actuator 303, and perceive inputs from real-world domain events 304 through the Events Interface 250. The real-word domain events refer to changes or occurrences that are perceived by the disclosed AI-based expert system.

The system can perceive information and input from real-world domain events 304 through the Events Interface 250, then the Reasoning and Decision Agent 260 directs its attention 301 to selectively focus on data that is relevant to ongoing tasks. The ongoing tasks refer to the operations run by the disclosed system in response to the operator's request and achieve the defined objective.

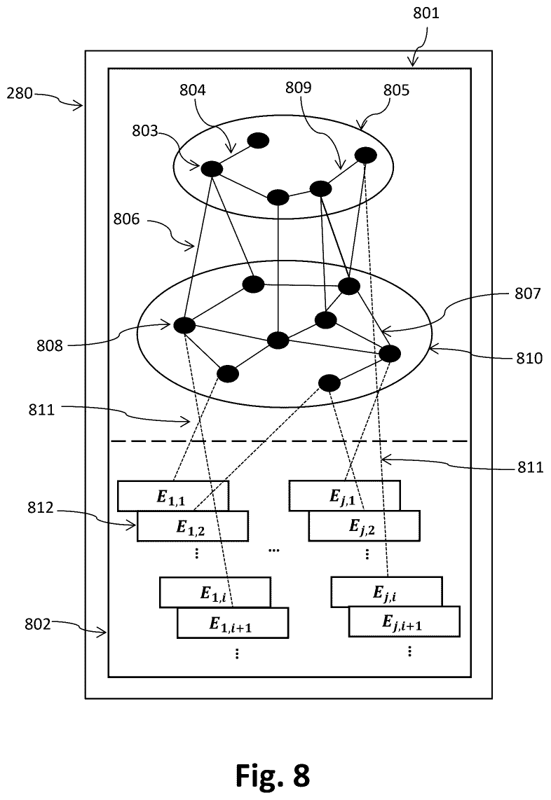

Referring to FIG. 8, the Semantic Domain Knowledge Space (SDKS) 280 acts as a semantic memory and contains a knowledge graph 801 that encapsulates knowledge using vertices 808 and edges 807. The vertices represent significant keywords and concepts from the domain of expertise. The domain of expertise refers to the specialized field of knowledge, industry, or discipline that the AI-based expert system is currently operating in, while the edges denote their semantic relationships and the frequency with which they co-occur. The Semantic Domain Knowledge Space 280 can be saved in a local or cloud digital storage 308. It is to be noted that any suitable storage and database can be used without departing from the scope of the present invention. The Deliberation Agent 270 can store the consolidated history of interactions in the Semantic Domain Knowledge Space 280. This consolidated knowledge will be used as prior knowledge by the Reasoning and Decision Agent 260 when processing future requests received from the operator device.

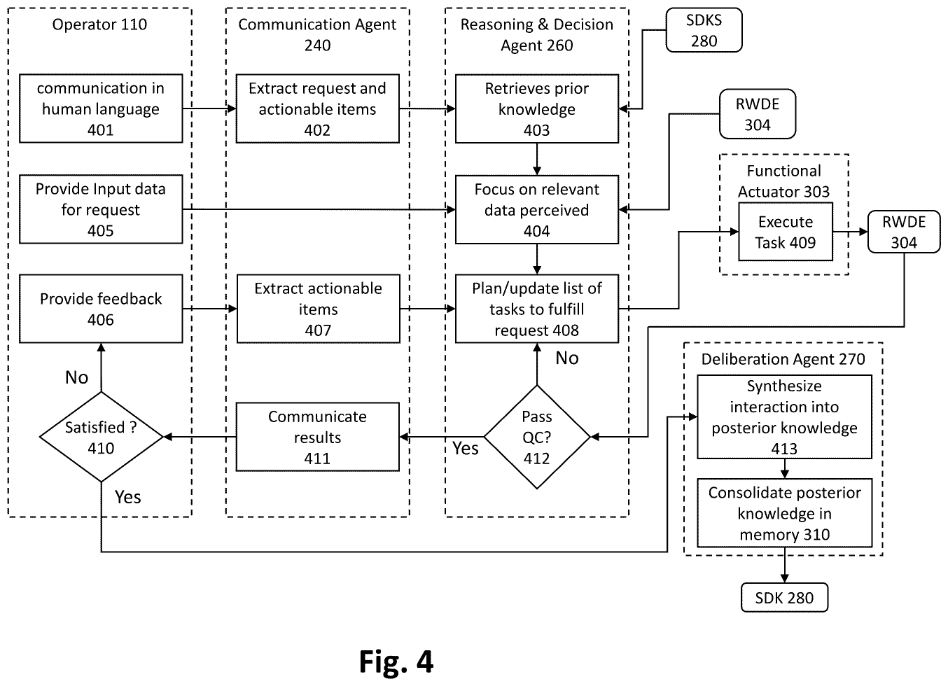

FIG. 4 Illustrates the steps involved in an example workflow of an operator using the AI-based Expert System (AIES) 100. In various implementations, an operator uses human language 401 to interact with the AIES 100 through the Communication Agent (CA) 240. The Communication Agent 240 is responsible for extracting requests from interactions 402 with the operator and forwarding them to the Reasoning & Decision Agent (RDA) 260. Then, the Reasoning And Decision Agent 260 initiates a consideration 302 process during which, it retrieves information relevant to the current task as prior knowledge 403 from the Semantic Domain Knowledge Space (SDKS) 280, uses attention to selectively focus its attention 301 only on relevant data in the information received from operator and information perceived from real-world domain events 304 through the Events Interface 250, and subsequently decides on a list of tasks 408 to execute to fulfill the operator's requests. For example, an operator in an oil and gas facility requests the communication agent to initiate a maintenance check on a pipeline segment due to pressure fluctuations. The reasoning agent identifies key terms like “maintenance check” and “pipeline segment,” then searches the semantic memory (SDKS 280) for prior knowledge like historical well data and maintenance procedures. The agent retrieves this information and analyzes it to determine whether maintenance is required. If maintenance is needed, it plans and schedules the necessary inspections and alerts the maintenance team accordingly.

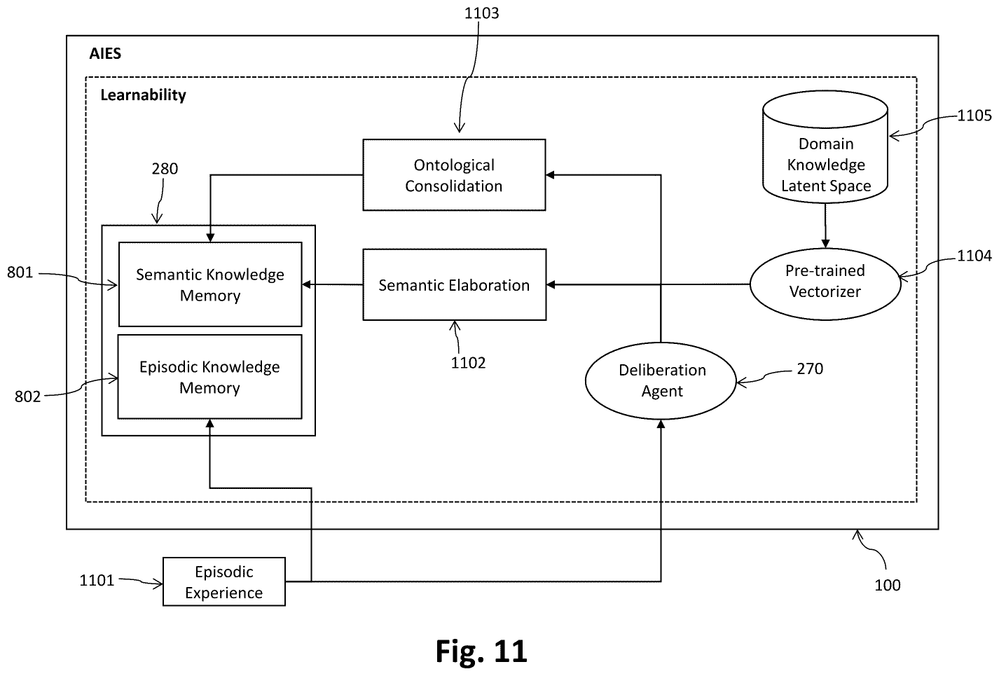

The Reasoning and Decision Agent 260 can issue commands to an external functional actuator 303 to perform the actions required 409 to complete the current request. The Reasoning and Decision Agent 260 performs quality control 412 to ensure the tasks are executed as expected. After execution, the operator can provide feedback 406 to the AIES 100, prompting the Reasoning and Decision Agent 260 to either continue or restart the consideration 302 process and adjust the list of tasks 408 to be executed as needed. This process is iterative, with each interaction being recorded and registered 305, and continues until the operator attains satisfaction. The Deliberation Agent (DA) 270 synthesizes the recorded interaction 413 and consolidates it as posterior knowledge 306, which then becomes available as prior knowledge for the Reasoning and Decision Agent 260 to consider when answering future requests. The consolidation process is further explained in FIG. 11. This ensures that the operator will not need to provide the same feedback when requesting similar tasks from the disclosed system 100 in the future.

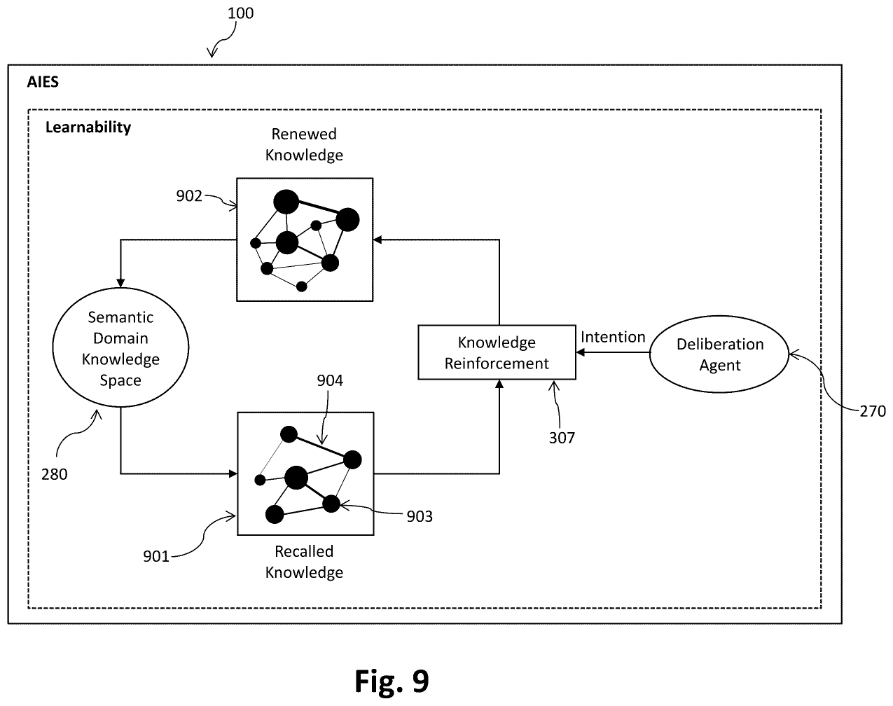

Furthermore, without requiring an operator's intervention, the Deliberation Agent 270 initiates a knowledge reinforcement 307 process targeting specific knowledge that it intends to reflect on. In this process, the Deliberation Agent 270 strengthens important concepts, forgets deprecated information, and finds new insights about the recalled knowledge before renewing it in the Semantic Domain Knowledge Space 280. These processes are illustrated in detail in FIG. 9.

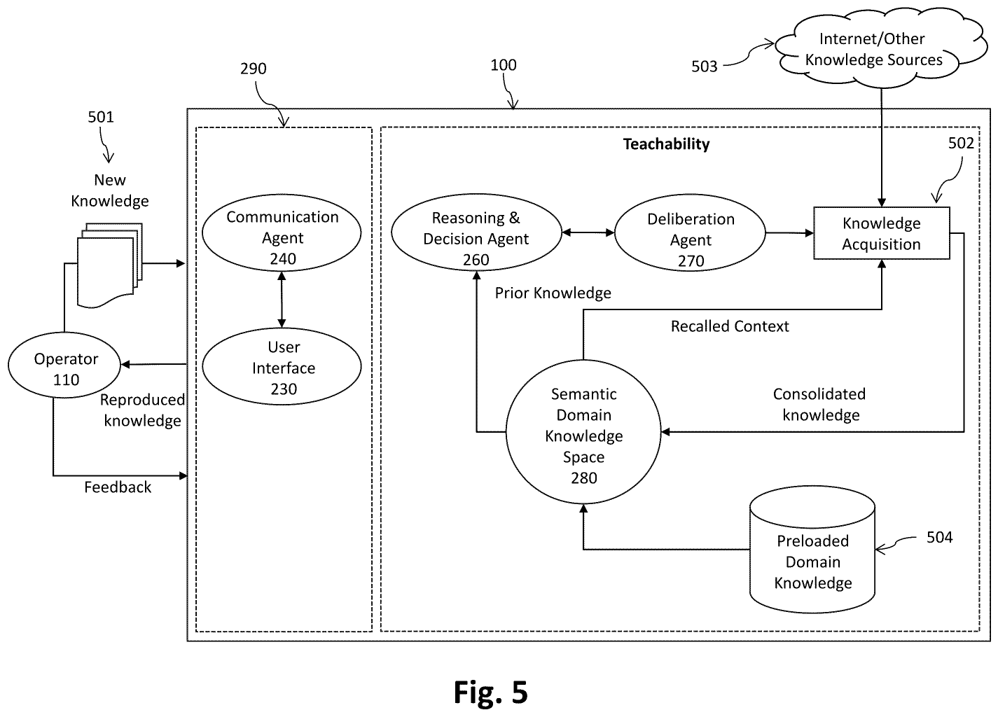

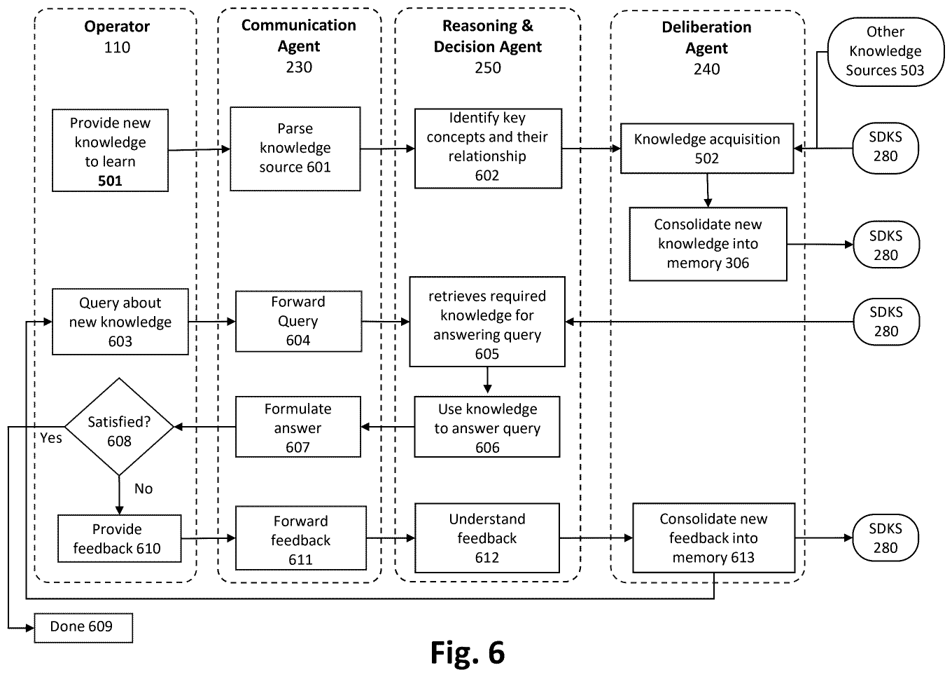

Referring to both FIG. 5 and FIG. 6, which illustrate training of the system with new knowledge 501 through the User Interface 230. FIG. 5 shows the components of the system architecture involved in the training process. FIG. 6 shows the procedural flow and the actions taken by these components or modules during the training process.

This interface is part of the Input/Output (I/O) module 290 of the AIES 100, which enables it to use different types of communication protocols to send and receive information from its environment. The new knowledge can take the form of documents, such as reports, research papers, and case studies, as well as unstructured documents, such as articles, meeting notes, and white papers. Broadly speaking, the system 100 can receive an electronic document or access it through a database, file system, or similar means. It can also be information provided by operators through direct communication with the AIES 100 through the user interface 230, including text and speech. Conversion from speech to text is performed by a speech-to-text algorithm, which can be implemented by any person skilled in the art. The Communication Agent 240 parses the new knowledge 601 provided and forwards it to the Reasoning and Decision Agent (RDA) 260. The parsing process converts the raw data contained in this new knowledge into a structured format that can be easily understood and manipulated by the RDA 260. The RDA then extracts keywords, concepts, and their relationships 602, then sends them to the Deliberation Agent (DA) 270 with instructions to learn the new knowledge 501. The Deliberation Agent 270 initiates a knowledge acquisition process 502 to consolidate domain-relevant information from the provided knowledge. In this process, the Deliberation Agent 270 recalls existing information in the Semantic Domain Knowledge Space 280 for context to better understand the keywords and concepts in the new knowledge 501. This prior information comes from domain knowledge 504 preloaded into the system. Optionally, the Deliberation Agent 270 also uses other knowledge sources 503 to refine or enhance its understanding of key terms and concepts in the new knowledge 501. Other knowledge sources 503 include information made available to the system 100 through an external database or the internet. Through the knowledge acquisition process 502, the Deliberation Agent 270 consolidates new knowledge 306, including important concepts, their contextual meaning, and their relationships from the new knowledge 501, then stores them in the Semantic Domain Knowledge Space 280. The operator verifies what the system 100 has learned from the new knowledge 501 by asking targeted questions from the system or prompting the system to reconstruct the learned knowledge 603. To respond to the operator's request, the Reasoning and Decision Agent 260 retrieves relevant information 605 related to the keywords in the request from the semantic memory (SDKS 280), which now includes the newly acquired knowledge.

Then, the operator provides feedback 610 or corrections to the AIES 100. The Reasoning and Decision Agent 260 processes the feedback and identifies the information that needs to be added or corrected 612, then forwards the feedback to the Deliberation Agent 270 for consolidation into memory 613. The operator keeps on prompting the system and providing feedback until they are satisfied with what the AIES 100 has learned.

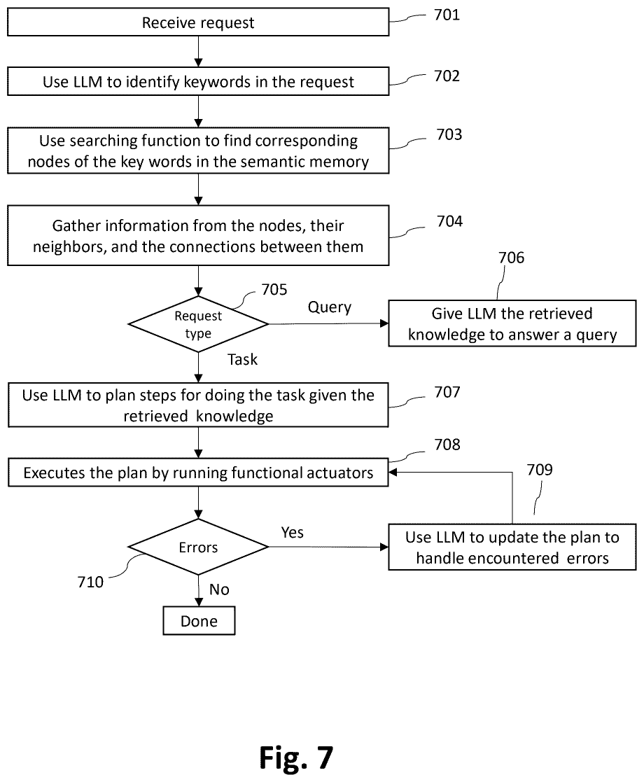

FIG. 7 details the methodology used by the Reasoning and Decision Agent 260 for processing requests. Upon reception of request 701, the Reasoning and Decision Agent 260 uses a Large Language Model (LLM) to identify any keywords 702, including entities, concepts, action verbs, etc. The Reasoning and Decision Agent 260 then searches for prior knowledge or relevant information about these keywords 703 by searching for their corresponding nodes in semantic memory 280 and retrieves relevant information from these nodes and their connections 704. Subsequently, the Reasoning and Decision Agent 260 generates a response based on the type of request. If the request is a query or a question, then the Reasoning and Decision Agent 260 employs an LLM to generate the answer to the question based on the prior knowledge collected 706. If the request is a task, then it uses an LLM to generate a plan or a sequence of steps for performing the task, given the retrieved knowledge 707. The Reasoning and Decision Agent 260 executes the plan by running the necessary functional actuators 708, enabling it to interact with other software components and control hardware. The Reasoning and Decision Agent 260 verifies the result after each step of the plan and corrects the plan accordingly 709 in case of errors, unexpected outputs, or general malfunctions encountered when running the functional actuators 710.

FIG. 8 illustrates in more detail the components of the Semantic Domain Knowledge Space (SDKS) 280. The Semantic Domain Knowledge Space 280 includes a Semantic Knowledge Memory (SKM) 801 and an Episodic Knowledge Memory 802. In this embodiment, the SKM 801 is a knowledge graph that contains vertices 803 and 808, and edges 804 and 807 corresponding to key terms and their relationships, respectively. The knowledge graph comprises low and high levels of abstractions. FIG. 8 depicts two layers, for simplicity without loss of generality, corresponding to low levels of abstraction 810 and high levels of abstraction 805. In lower levels of abstraction 810, a vertex 808 corresponds to a key term that refers to entities appearing in the current domain of expertise of the AIES 100. These entities include but are not limited to objects, products, locations, organizations, algorithms, scientific terms, technical jargon, etc. These entities are found in text by an LLM or by using a Named Entity Recognition (NER) algorithm, which can be implemented by any person of ordinary skill in the art. In lower levels of abstraction 810, an edge 807 between two vertices represents the semantic relationship and the frequency of co-occurrence of their corresponding key terms. In higher levels of abstraction 805, a vertex 803 corresponds to more abstract concepts and knowledge about the domain of expertise that provides context to entities in lower levels of abstraction 810. A vertex 803 or 808 has attributes such as weight, vector representation, and pointers to other data. An edge 806 between vertices from different levels of abstraction, such as vertex 803 and 808 in this example, represents different kinds of relationships, including, but not limited to, subclass, inheritance, type, taxonomic, instantiation, etc. An edge 804 between two vertices in higher levels of abstraction 805 represents a semantic relationship between the corresponding concepts. An edge 809 exists between two vertices if there exists a path in the lower levels of abstraction 810 connecting them. The SKM 801 can be generated before the start of operation by providing a glossary of keywords and concepts relevant to the domain of expertise.

An operator can supply knowledge to the system 100 through various means, such as text documents, reports, and direct system prompts. This information can then be divided into sequential sentences before being stored in memory. The provided information is converted into text, segmented into paragraphs, and further divided into sentences, while maintaining their original sequence. Each sentence is referred to as episode 812. In this embodiment, the Episodic Knowledge Memory (EKM) 802 is a database for storing episodes. A vertex 803 or 808, corresponding to a specific keyword or concept, has a pointer 811 to an episode containing that keyword. Episodes are merged based on a similarity threshold. This process is explained further in FIG. 9.

When operator 110 requests from the AIES 100 to retrieve information related to specific keywords, it prompts the Reasoning and Decision Agent (RDA) 260 to search for the SKM 801 for the vertices corresponding to those keywords. The Reasoning and Decision Agent 260 then follows the edges linked to those vertices to identify additional vertices that correspond to other keywords relevant to the operator's query. Then, the Reasoning and Decision Agent 260 searches the EKM 802 for episodes that are referenced by the relevant vertices and utilizes them to provide the operator 110 with the most accurate information possible.

FIG. 9 describes a procedure during which the AI-based Expert System (AIES) 100 engages in cognitive processes that allow for the reinforcement of existing concepts or the discovery of new insights related to the domain of expertise. When the AIES 100 is at rest, without intervention from an operator 110, the Deliberation Agent (DA) 270 intends to reflect on specific pieces of knowledge in memory and starts the knowledge reinforcement 307 process. The intention of the Deliberation Agent 270 is driven by recent interactions with the AIES 100 and its external environment. This knowledge reinforcement 307 process starts by recalling knowledge related to a specific topic from the Semantic Domain Knowledge Space (SDKS) 280 based on the intention of the Deliberation Agent 270. The Deliberation Agent 270 intends to reinforce its knowledge of a topic based on its importance, frequency, or relevance in recent interactions with the operator, including requests, feedback, and received data. The recalled knowledge 901 is in the form of vertices 903 and edges 904 corresponding to the targeted concepts and their relationships, respectively. In this embodiment, a vertex 903 has a weight that represents the importance and frequency of occurrence of its corresponding concept. Keywords that appear frequently within a short timeframe are assigned to a greater weight compared to those that occur over a longer timeframe. An edge 904 has a weight that represents the frequency of co-occurrence of the concepts corresponding to its vertices. In FIG. 9, the weight of vertices 903 and edges 904 are represented by their size and thickness, respectively. Deliberation Agent 270 reflects on the recalled knowledge 901 by adjusting the weights of vertices 903 and edges 904. The Deliberation Agent 270 strengthens a concept in the recalled knowledge 901 by increasing the weight of its corresponding vertex 903. It also strengthens the connection between the two concepts by increasing the weight of the edge 904 corresponding to that connection. The Deliberation Agent 270 weakens a concept in recalled knowledge 901 by decreasing its corresponding vertex 903. It also weakens the connection between the two concepts by decreasing the weight of the edge 904 corresponding to that connection. The Deliberation agent forgets about concepts and connections by deleting their corresponding vertices and edges if their weights fall below a certain threshold. The Deliberation Agent 270 adds new vertices and connections when it finds new insights into the recalled knowledge 901. The renewed knowledge 902 resulting from the knowledge reinforcement 307 process is then saved in the Semantic Domain Knowledge Space 280, making it available for future operations. This procedure allows the AIES 100 to learn by reinforcing important knowledge, forgetting deprecated and outdated information, and potentially uncovering new insights related to the domain of expertise. New insights refer to the discovery of previously unknown patterns or connections in data, leading to a better understanding of existing knowledge and the generation of new ideas.

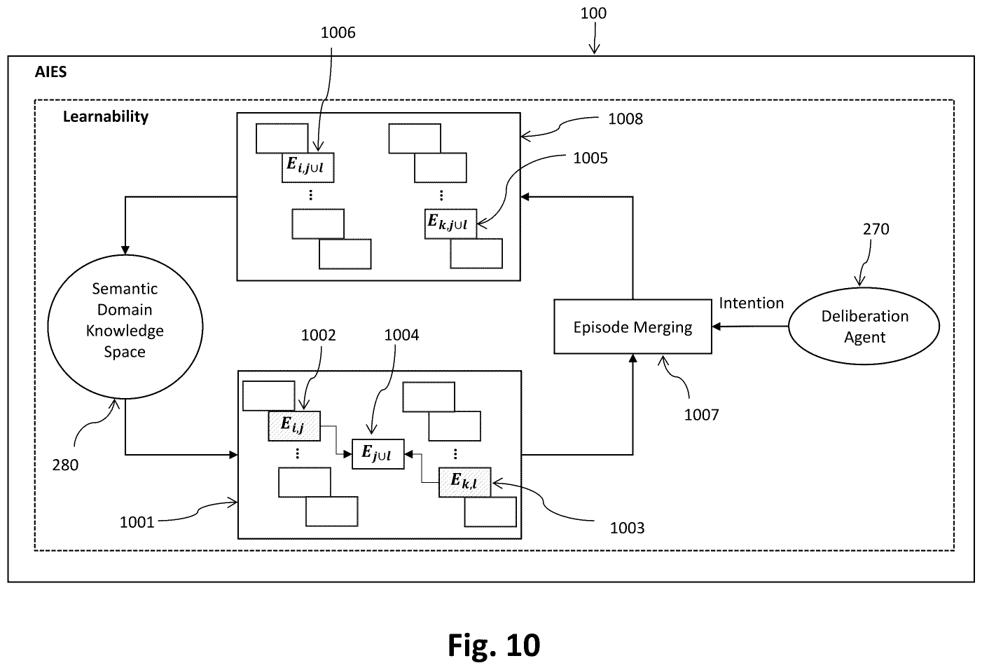

FIG. 10 describes the episode merging process 1007 that is initiated by the Deliberation Agent (DA) 270 after knowledge reinforcement 307. The process starts by recalling the sequence of episodes 1001 that are pointed at 811 by the vertices that were updated or created during the knowledge reinforcement 307 step. These vertices represent keywords found in the recalled episodes. When one episode 1002 and another episode 1003 share common vertices, it indicates that these episodes have multiple similar keywords. If more than 75% of the keywords in these episodes overlap, they are combined into a single episode 1004 that includes all the keywords. The Deliberation Agent 270 applies its reasoning to merge the episodes coherently, ensuring minimal loss in both syntax and semantics. Consequently, episode 1002 and episode 1003 are removed and substituted with the merged episodes 1005 and 1006, respectively, within the sequence. The updated episode sequence 1008 is then stored back into memory. This process allows the AIES 100 to organize its episodic memory 802 by forgetting redundant information, thereby enabling it to produce precise answers tailored to the operator's queries.

FIG. 11 illustrates the process of knowledge consolidation performed by the AIES 100. An episodic experience 1101 refers to the duration between when an operator begins and completes their use of the AIES 100. During an episodic experience 1101, operator 110 provides knowledge to the AIES 100, which will be recorded in the Semantic Domain Knowledge Space 280. This knowledge can be input in different ways, including text documents, reports, and through directly prompting the system. The knowledge provided is divided into episodes 812 and stored in the EKM 802, while the Deliberation Agent 270 initiates two processes—Semantic Elaboration 1102 and Ontological Consolidation 1103—to store the knowledge in the SKM 801. The Deliberation Agent 270 finds and extracts relevant keywords, their semantic context, and the frequency of their co-occurrence. Then, it uses pre-trained vectorizer 1104 to generate vector embeddings representing the extracted keywords based on their semantic context. Vectorizer 1104 generates embedding from a latent space 1105 where domain knowledge of the current field of expertise is encoded. The Deliberation Agent 270 then starts the semantic elaboration 1102 process to add the keywords into the SKM 801 in the form of vertices and edges based on their embeddings and their frequency of co-occurrence. The embeddings are used to find an existing vertex that corresponds to a keyword or find vertices corresponding to other keywords with close semantic context. The Deliberation Agent 270 stores keywords into SKM 801 by adding, updating, or removing vertices based on the semantic context of their corresponding keywords. The Deliberation Agent 270 updates the relationship between the relevant vertices by adding, updating, or removing edges based on the frequency of co-occurrence and the semantic relationship of their corresponding keywords. The frequency of co-occurrence of keywords is tracked throughout episodic experiences. To illustrate, an edge is created when two keywords appear together in a sentence or paragraph for the first time. The weight of the edge is updated based on the recent frequency of their co-occurrence. If the co-occurrence frequency of the two keywords falls below a certain threshold, the edge is removed. After semantic elaboration 1102, the Deliberation Agent 270 starts the ontological consolidation 1103. In this process, The Deliberation Agent 270 adds new concepts or relationships, updates attributes, or redefines the hierarchy or structure of the existing ontology of the SKM 280, especially in higher levels of abstraction 805. For example, the Deliberation Agent 270 adds new classifications or subcategories based on the specificity or generality of the new concepts relative to existing ones. It also identifies any potential ripple effects across related concepts and relationships and updates them accordingly.

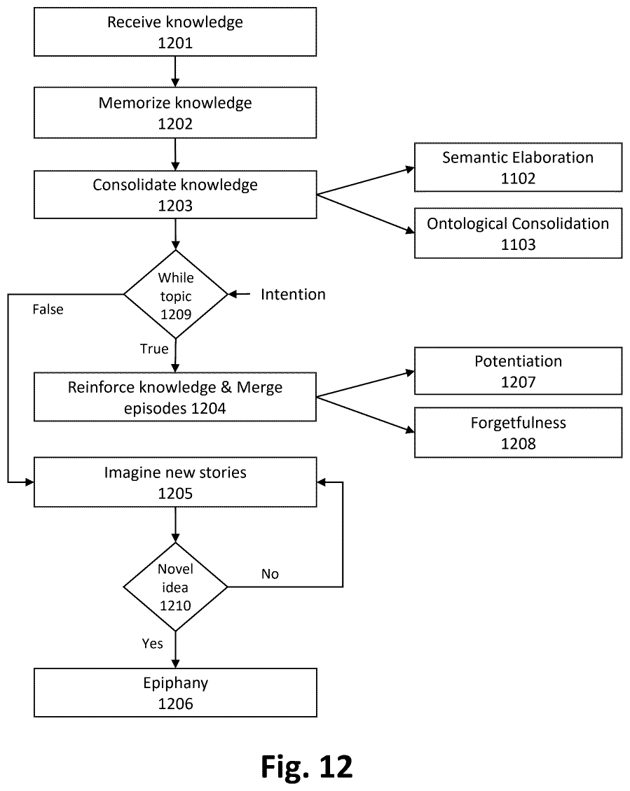

FIG. 12 illustrates how the AI-based Expert System (AIES) 100 replicates specific cognitive functions of the human brain, including learning, reinforcing knowledge, forgetting outdated information, and creating new stories. These capabilities allow AIES 100 to experience “epiphanies”. The process begins when the AIES 100 receives knowledge 1201 from an Operator via the user interface 230. In this instance, the knowledge is delivered as an electronic document. In other scenarios, the operator 110 provides new knowledge using natural language, either through text prompting or speech. The AIES 100 memorizes the provided knowledge 1202 by storing it in memory 280. Specifically, the provided document is divided into episode 812 and saved in Episodic Knowledge Space (EKS) 802. After the new knowledge is stored, the next step is knowledge consolidation 1203. During this phase, the AIES 100 identifies key concepts within the new document and integrates them with pre-existing concepts in memory 280. This phase starts with storing in SKM 801 the key concepts and their relationships found in the new document as nodes and edges via semantic elaboration 1102 as described in FIG. 11. It is to be noted that the terms nodes and vertices are used interchangeably herein. The existing ontology of the semantic memory 801, including the hierarchical relationships between keywords and concepts, is revised to reflect recent modifications made in the previous step through Ontological Consolidation 1103, also detailed in FIG. 11.

While there is an intention for the AIES 100 to reinforce its knowledge 1209 pertaining to a particular topic or domain, it utilizes two processes inspired by the cognitive functions involved in knowledge reinforcement in the human brain: Long-Term Potentiation 1207 and Long-Term Depression, referred to as forgetfulness 1208 in FIG. 12. During the potentiation step 1207, pertinent nodes and edges related to the selected topic are identified and retrieved. Then the weights of nodes and edges corresponding to keywords that are crucial for understanding the topic within the scope of its current domain of expertise are increased. In the forgetfulness step 1208, the weights of nodes and edges decrease as the relevance of their associated keywords to the chosen topic diminishes. If a weight drops below a predetermined threshold, the corresponding nodes and edges are removed from memory. After the semantic memory 801 is updated, the process of episode merging 1007 is triggered to combine episodes that share common keywords as described in FIG. 10. This guarantees that only important information is remembered and outdated knowledge is forgotten. This process is iterated until the AIES 100 has no further topics it intends to reinforce its knowledge about.

Following the knowledge reinforcement process, to get an epiphany, the AIES 100 emulates imagination (process 1205), a cognitive function crucial for creativity. By logically traversing the relationship between concepts and keywords in memory, it infers new connections between seemingly distant concepts and generates new ideas and stories, effectively simulating the imaginative process. Through an iterative process, finding new connections between concepts will generate different stories, until the AIES 100 finds a novel idea 1210 that is relevant to the current domain of expertise. At that point, it is said that the AIES 100 got an epiphany 1206 and will report it to the operator 110 for feedback.

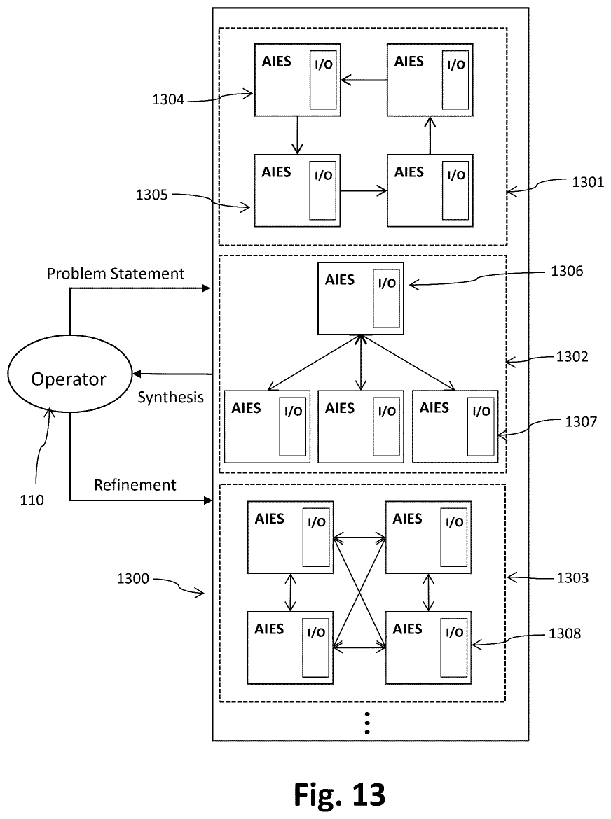

FIG. 13 illustrates an operational mode that leverages multiple AI-based Expert Systems (AIES) 100 to brainstorm new ideas at the request of an operator 110. The operator establishes a collaborative environment 1300, which is any digital or physical space enabling communication among the AI-based expert systems via their input/output (I/O) module 290. These AI-based expert systems can have different domain knowledge, enabling cross-domain reasoning by sharing ideas and concepts from different backgrounds until a consensus is achieved. At the end of the brainstorming session, the expert systems consolidate the outcome of the session and update their respective memory.

In the following, a brainstorming session featuring four expert systems is illustrated. Nonetheless, this approach applies to any number of AI-based expert systems engaging in communication with one another. The interaction between the AI-based expert systems can be organized with different communication patterns. For example, a ring communication pattern 1301 where expert systems are arranged in a logical ring and interact sequentially with the next system in the loop. The cycle begins with a starting expert system 1304, which initiates communication by sending a query to the next system in line. Each system in cycle 1305 then utilizes its reasoning and prior knowledge to find or guess the best answer to the query before passing both the response and the query to the next system. Once the cycle is complete, the initial expert system 1304 gathers all the reasoning and responses related to the original query and begins its deliberation. If additional information is needed, the starting expert system 1304 restarts the cycle with a new or revised query. Otherwise, it synthesizes the final answer and returns it to the operator 110.

Another approach for organizing AI-based expert systems in a collaborative environment 1300 is the contract-net protocol 1302. Here, one system functions as the manager 1306, sending queries to other systems that serve as workers 1307. The manager evaluates the workers' responses and employs their reasoning to decide whether to issue another query, select the optimal response, or synthesize a new response based on the gathered information. Another example is a distributed consensus pattern 1303 where no single AI system 1308 acts as a central authority. Instead, AI systems communicate freely among themselves, sharing information, making queries, and responding to requests. Each system applies its own reasoning based on its prior knowledge and the information shared by other systems. The AI-based expert systems continue their interactions until they reach a consensus. The patterns described thus far are not exhaustive, and someone skilled in the field can choose and implement a pattern that best suits their specific use case.

At the end of each brainstorming session, the operator 110 receives the synthesized response produced by the collaboration of the AI systems. The operator then proposes refinements and initiates another round of brainstorming. This feedback loop continues until the operator is satisfied with the outcome. At the end of the brainstorming session, the original AIES 100 saves the relevant insights into its memory.

As the general concept of the present invention has been defined, it is important to note that the present invention presents clear advantages in real-world environmental conditions. The AI-based expert system is an evolutionary system that adapts and evolves during operation with its environment, unlike other expert systems, which require frequent and costly interventions to keep them up to date. Current expert systems have limited reasoning capabilities, which impair their flexibility with new tasks and their abilities to help the human operator with making decisions, especially about new information and scenarios. The AI-based expert system uses prior knowledge and human feedback learned throughout its service life to update its behavior to fit the operator's needs and guarantee their satisfaction. Additionally, multiple AI-based expert systems with different domain knowledge can collaborate and share information to brainstorm and get epiphanies about new ideas and insights that help the operator in their decision-making process.

What is claimed is:

1. An AI-based expert system capable of reasoning, learning, and imagination, the AI-based expert system comprises a processor and a memory, the AI-based expert system is configured to implement a method comprising:
receive, via a communication agent, a request in natural language from an operator device through a user interface, wherein the communication agent utilizes a large language model to facilitate natural language interaction;
identify, by a Reasoning and Decision Agent, key phrases from the request;
determine, by the Reasoning and Decision Agent, a current task based on the key phrases;
retrieving, by the Reasoning and Decision Agent, prior knowledge relevant to the current task from a Semantic Domain Knowledge Space comprising an episodic knowledge space and a semantic knowledge space, wherein the semantic knowledge space comprises a knowledge graph, the knowledge graph comprises vertices and edges;
process, by the Reasoning and Decision Agent, the prior knowledge based on the request to generate a list of tasks;
transmit, by the Reasoning and Decision Agent, the list of tasks as commands to a functional actuator; and
execute, by the functional actuator, one or more actions based on the transmitted commands.

2. The AI-based expert system of claim 1, wherein the Reasoning and Decision Agent is further configured to retrieve relevant information, for the current task, from real-world domain events, through sensors or data feed, wherein the Reasoning and Decision Agent processes the relevant information and the prior knowledge to generate the list of tasks.

3. The AI-based expert system of claim 1, wherein the Semantic Domain Knowledge Space is configured to encapsulate knowledge as vertices and edges in the knowledge graph, wherein the vertices represent keywords and concepts from a domain of expertise and edges denote semantic relationships of the keywords and concepts and frequency with which the keywords and concepts co-occur.

4. The AI-based expert system of claim 1, wherein the method further comprises:
storing, by a Deliberation Agent, a consolidated history of the request, the current task, and the corresponding list of actions as the prior knowledge in the Semantic Domain Knowledge Space.

5. The AI-based expert system of claim 1, wherein the method further comprises:
receive, by the communication agent, new knowledge;
parse, by the communication agent, the new knowledge into a structured format;
extract Keywords, concepts, and their relationships from the structured new knowledge, by the Reasoning and Decision Agent;
initialize a knowledge acquisition process by a Deliberation Agent, wherein the knowledge acquisition process comprises recalling existing information in the Semantic Domain Knowledge Space for context to better understand the keywords and concepts in the new knowledge; and
consolidate, by the Deliberation Agent, the new knowledge, including important concepts, their contextual meaning, and their relationships in the Semantic Domain Knowledge Space.

6. The AI-based expert system of claim 1, wherein the episodic knowledge space is a digital storage module configured to store episodes in a sequence they appear in a perceived electronic document, wherein an episode is a segment of text referenced by the vertices in the knowledge graph, with each vertex corresponding to a term present within that segment of text.

7. The AI-based expert system of claim 6, wherein the semantic knowledge space comprises high levels of abstraction and low levels of abstraction, wherein the vertices represent concepts and keywords, and the edges represent relationships between concepts and keywords, wherein each vertex is linked to the episodes containing the corresponding concepts and keywords.

8. The AI-based expert system of claim 5, wherein the method further comprises:
reinforce recalled knowledge about concepts and their relationships through potentiation and forgetfulness; and
renew the reinforced knowledge into the semantic knowledge space,
wherein the potentiation is increasing the weight of existing vertices and edges, and adding vertices and edges corresponding to the recalled concepts and relationships,
wherein the forgetfulness is reducing the weight of vertices and edges, and deleting vertices and edges corresponding to the recalled concepts and relationships.

9. The AI-based expert system of claim 8, wherein the method further comprises:
combine, by the deliberation agent, recalled episodes within the episodic knowledge space into one episode when there is a predetermined number of common vertices referring to these episodes in the semantic knowledge space.

10. The AI-based expert system of claim 9, wherein the method further comprises:
initiate imagination by exploring and creating new connections between concepts within the semantic knowledge space; and
generate new insights and stories based on the new connections.

11. A method for reasoning, learning, and imagination, the method implemented within an AI-based expert system comprises a processor and a memory, the method comprising:
receiving, by a communication agent, a request in natural language from an operator device through a user interface, wherein the communication agent utilizes a large language model to facilitate natural language interaction;
identifying, by a Reasoning and Decision Agent, key phrases in the request;
determining, by the Reasoning and Decision Agent, a current task based on the key phrases;
retrieving, by the Reasoning and Decision Agent, prior knowledge relevant to the current task from a Semantic Domain Knowledge Space comprising episodic knowledge space and semantic knowledge space, wherein the semantic knowledge space comprises a knowledge graph, the knowledge graph comprises vertices and edges;
processing, by the Reasoning and Decision Agent, the prior knowledge based on the request to determine a list of tasks;
receiving, by a functional actuator, the list of tasks as commands from the Reasoning and Decision Agent; and
executing one or more actions, by the functional actuators, based on the commands.

12. The method of claim 11, wherein the Reasoning and Decision Agent is further configured to retrieve relevant information for the current task from real-world domain events, through sensors or data feed, wherein the Reasoning and Decision Agent processes the relevant information and the prior knowledge to determine the list of tasks.

13. The method of claim 11, wherein the Semantic Domain Knowledge Space is configured to encapsulate knowledge using vertices and edges in the knowledge graph, wherein the vertices represent keywords and concepts from a domain of expertise and edges denote semantic relationships of the keywords and concepts and frequency with which the keywords and concepts co-occur.

14. The method of claim 11, wherein the method further comprises:
storing, by a Deliberation Agent, a consolidated history of the request, the current task, and the corresponding list of actions as the prior knowledge in the Semantic Domain Knowledge Space.

15. The method of claim 11, wherein the method further comprises:
receiving, by the communication agent, new knowledge;
parsing, by the communication agent, the new knowledge into a structured format;
retrieving keywords, concepts, and their relationships from the structured new knowledge, by the Reasoning and Decision Agent;
initializing a knowledge acquisition process by a Deliberation Agent, wherein the knowledge acquisition process comprises recalling existing information in the Semantic Domain Knowledge Space for context to better understand the keywords and concepts in the new knowledge; and
consolidating, by the Deliberation Agent, the new knowledge, including important concepts, their contextual meaning, and their relationships in the Semantic Domain Knowledge Space.

16. The method of claim 11, wherein the episodic knowledge space is a digital storage module configured to store episodes in a sequence they appear in a perceived electronic document, wherein an episode is a segment of text referenced by the vertices in the knowledge graph, with each vertex corresponding to a term present within that segment of text.

17. The method of claim 16, wherein the semantic knowledge space comprises high levels of abstraction and low levels of abstraction, wherein the vertices represent concepts and keywords, and the edges represent relationships between concepts and keywords, wherein each vertex is linked to the episodes containing the corresponding concepts and keywords.

18. The method of claim 15, wherein the method further comprises:
reinforcing recalled knowledge about concepts and their relationships through potentiation and forgetfulness; and
renewing the reinforced knowledge into the semantic knowledge space,
wherein the potentiation is increasing a weight of existing vertices and edges, and adding vertices and edges corresponding to the recalled concepts and relationships,
wherein the forgetfulness is reducing the weight of vertices and edges, and deleting vertices and edges corresponding to the recalled concepts and relationships.

19. The method of claim 18, wherein the method further comprises:
combining, by the deliberation agent, recalled episodes within the episodic knowledge space into one episode when there is a predetermined number of common vertices referring to these episodes in the semantic knowledge space.

20. The method of claim 19, wherein the method further comprises:
initiating imagination by exploring and creating new connections between concepts within the semantic knowledge space; and
generating new insights and stories based on the new connections.
